(19) United States
(12) Patent Application Publication
(10) Pub. No.: US 2009/0132463 A1
(43) Pub. Date: May 21, 2009

(54) SYSTEM AND METHOD FOR FACILITATING TRANSITION BETWEEN IBM® WEBSPHERE® MQ WORKFLOW AND IBM® WEBSPHERE® PROCESS SERVER

(75) Inventor: Eric Ducos, Eagle Mountain, UT (US)

Correspondence Address: HOVEY WILLIAMS LLP, 10801 Mastin Blvd., Suite 1000, Overland Park, KS, 66210, US

(73) Assignee: EMERICON, L.L.C., Shawnee Mission, KS (US)

(21) Appl. No.: 12/273,315

(22) Filed: Nov. 18, 2008

Related U.S. Application Data
(60) Provisional application No. 61/003,683, filed on Nov. 19, 2007.

(51) Int. Cl. G06F 15/16; G06F 17/30

(52) U.S. Cl. 707/1; 709/203; 707/E17.001

(57) ABSTRACT

A computer program for allowing a client computer program written to communicate with WMQWF to communicate with computing elements running WMQWF or WPS includes a receiving code segment receiving said requests from a WMQWF client library, a target device selection code segment for determining a target device from said request and a list of said computing elements, a first transformation code segment for transforming said request from a format understood by said client computer program to a format understood by said target device, a dispatch code segment for sending said request to said target device, a monitor code segment for waiting for a response from said target device, a second transformation code segment for transforming said response from a format understood by said target device to a format understood said client computer program, and a response code segment for providing said response to said client code segment.

### RELATED APPLICATION

This nonprovisional patent application claims priority benefit, with regard to all common subject matter, of an earlier-filed U.S. provisional patent application titled “Application Programming Interface and Method for Providing Software Compatibility”, Ser. No. 61/003,683, filed Nov. 19, 2007. The identified earlier-filed application is hereby incorporated by reference in its entirety into the present application.

### BACKGROUND OF THE INVENTION

1. Field of the Invention

This application relates to a system and method for facilitating a transition between IBM® WebSphere® MQ Workflow (WMQWF) and IBM® WebSphere® Process Server (WPS). More specifically, the invention relates to a computer program implemented in a machine readable format on computing devices which creates a compatibility layer around WMQWF and WPS so that any code segments written for WMQWF will operate without error if the program is executed in an environment consisting of only WMQWF servers, only WPS servers, or a heterogeneous environment of WMQWF and WPS servers.

2. Background

Business Process Management (BPM) software allows businesses to model and track business processes electronically. For example, such software may be used by a business or other entity to implement a purchase request process. An employee who wants to purchase an item for work requests the item through an interface to the BPM software, and the request is forwarded to a department manager. If the department manager approves the request and the cost of the item is below a set amount, the request is then forwarded to the purchasing department. If the department manager approves the request and the cost is above the threshold, it is forwarded to a company manager for approval. If the company manager approves the request, the request is forwarded to the purchasing department. The employee is notified whether the purchase request is approved or denied.

A popular BP software is IBM®'s WMQWF version 3.6. In accordance with the common software architecture patterns of the time it was written, WMQWF is based generally on a client-server model. In 2006, IBM® released WPS as the next generation of BPM software and supporting the latest standards and technologies. Thus, WPS supports many technologies, including Enterprise Java Beans (EJB) and Service Oriented Architecture (SOA) technologies, which its predecessor does not. In fact, while WPS is positioned as the next version of WMQWF, it is more accurate to say WMQWF and WPS are completely different product offerings that coincidentally achieve similar results. However, IBM® does expect users of WMQWF to eventually convert existing WMQWF installations to WPS. Unfortunately, customers are in a difficult position as there is no direct upgrade path between the two offerings because they are largely incompatible with each other.

WMQWF expresses business processes in Flow Definition Language (FDL) while WPS uses Business Process Execution Language (BPEL). These two representations contain syntactic, structural and, most importantly, semantic differences that make translation impossible, in some cases, without additional information. The semantic and syntactic differences between process models force the schemas for storage of those processes to be completely different. Finally, the generated business events created by WMQWF and WPS vary in format, granularity, meaning and context.

Externally, the differences between WMQWF and WPS are just as numerous. The primary interface points of WMQWF are the native Java API level, the Process Control Interface, the User Defined Program Execution Server (UPES), the Staffing API, the Java Authentication Interface and the Audit interface. None of these interface points are compatible between WMQWF and WPS. For these interface points, WMQWF uses a combination of Java libraries, C libraries, or XML messages sent over a Message Queue for interaction. WPS, in contrast, uses EJB, Web Services, or Web-based clients using JavaServer Faces.

Thus, due to the drastically different nature of these interfaces and of the content of the data, software written for WMQWF requires complete re-engineering to facilitate compatibility with WPS. Ideally, an upgrade from WMQWF to WPS would entail copying of data from WMQWF to WPS and then deactivating WMQWF. Unfortunately, this upgrade path has not been provided and there is no way to directly convert anything but a trivial WMQWF system to WPS.

In large organizations, BPM processes may number in the thousands or tens of thousands. Not only would the definitions, or models, of the processes in WMQWF need to be rewritten to support WPS, but the actual ongoing business processes handled by WMQWF in FDL format would, similarly, need to be migrated to WPS in BPEL format. Some of these business processes may have durations measured by months and years, further complicating a transition from one technology to another.

Thus, the only choice to move from WMQWF to WPS is a costly rewrite of existing software and reengineering of existing code and process models. In addition to the up-front cost of redesign, development and testing, businesses also face the additional costs of downtime and business processes improperly translated. In many corporations, there is insufficient business benefit to justify such costs when an existing system is in place and working properly. Eventually IBM® will retire support for WMQWF and businesses will be forced up upgrade to receive future support on their existing systems.

### SUMMARY

The present invention solves the above-described problems and advances the art by providing a more effective way to transition between WMQWF and WPS. More particularly, the present invention provides code segments that provide code-level compatibility between WMQWF and WPS and allows WMQWF and WPS to act in concert as a federated group where requests are executed on either WMQWF, WPS or both.

Client programs may request data for a variety of reasons. For example, a business may implement a web page that tracks the current status of all the purchase requests in the organization. The web page would, either directly or indirectly, make a request to the BPM software to return the status of all purchase requests in the organization. It is possible that the web page would request the purchase request data from a stateless session bean from an EJB container. The stateless session bean would utilize the WMQWF client library to login to WMQWF, execute a query for all the purchase requests, then logout of the system. The client program may also be a traditional application with a standalone graphical user interface.

The present invention intercepts requests for BPM data by client applications. The invention then calls one or more WMQWF or WPS servers, depending on the configuration and the specifics of the request. If a WMQWF server is called, the present invention is transparent and WMQWF is called directly without additional action by the invention. If a WPS server is called, in contrast, the intercepted calls are rerouted to an EJB called the WPS Conversion Service (Conversion Service). That service performs transformation of the data and then calls WPS. Once WPS returns its data, the Conversion Service performs additional translation of the returned data. The data is then returned to the client application. In situations where WMQWF and WPS servers are federated, the calls to WPS and WMQWF are executed simultaneously and the data is aggregated to provide the appearance of a single system before it is provided to the client.

The present invention provides a Java API component for providing this compatibility. An extension for WMQWF client libraries are supplied which dispatch requests directly to WMQWF using its native protocol, and to WPS using the Conversion Service deployed in an EJB container and, additionally, a web services interface to the same. Requests made to the Conversion Service, in turn, make an additional request the WPS server, transform any data that requires transformation and returns the data to the client library extension. The extension then returns the data to the client program.

In a mixed environment, certain requests will execute against a single server while others will execute on multiple servers simultaneously, depending on the action requested. For example, general queries will be executed against all servers and the data will be merged to provide the appearance of a single server. In contrast, requests for a single object will be dispatched only to the server on which it resides.

The present invention also provides an XML Message Queue API component. The process control API monitors an input message queue. When an appropriately formatted XML, message is placed in the queue, a listener application will read the message and determine what needs to be done to process the request. For requests destined for WMQWF servers, the message is simply re-queued in an appropriate queue monitored by WMQWF. For requests destined for WPS servers, a SOAP/HTTP request is made to the web service interface of the Conversion Service. When the request has been executed, an appropriate XML reply message is placed in a reply queue. Client programs interested in this information will monitor this queue for updates.

The XML Message Queue API also includes a dynamic cache component which is refreshed programmatically, by explicit refresh messages, and at the startup of the listener application.

The present invention also provides a Java Staffing API component for providing access to user/group or organizational information. This works in the same way as the Java API mentioned previously but additionally accesses a database with user and group information, such as an LDAP or a Microsoft® Active Directory® database.

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1 is a block diagram illustrating components of a computer system that may be used to implement embodiments of the invention.

FIG. 2 is a block diagram illustrating an embodiment of the invention that utilizes a single WMQWF device.

FIG. 3 is a block diagram illustrating an embodiment of the invention that utilizes aggregated WMQWF and WPS devices.

FIG. 4 is a block diagram illustrating an embodiment of the invention that utilizes a single WPS device.

FIG. 5 is a block diagram illustrating an embodiment of the invention that utilizes the message queuing interface.

FIG. 6 is a flowchart illustrating selected steps of a method in accordance with embodiments of the invention.

FIG. 7 is a flowchart illustrating selected steps of a method in accordance with embodiments of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the present invention references the accompanying drawings that illustrate specific embodiments in which the invention can be practiced. The embodiments are intended to describe aspects of the invention in sufficient detail to enable those skilled in the art to practice the invention. Other embodiments can be made without departing from the scope of the present invention. The following detailed description is, therefore, not to be taken in a limiting sense. The scope of the present invention is defined only by the appended claims, along with the full scope of equivalents to which such claims are entitled.

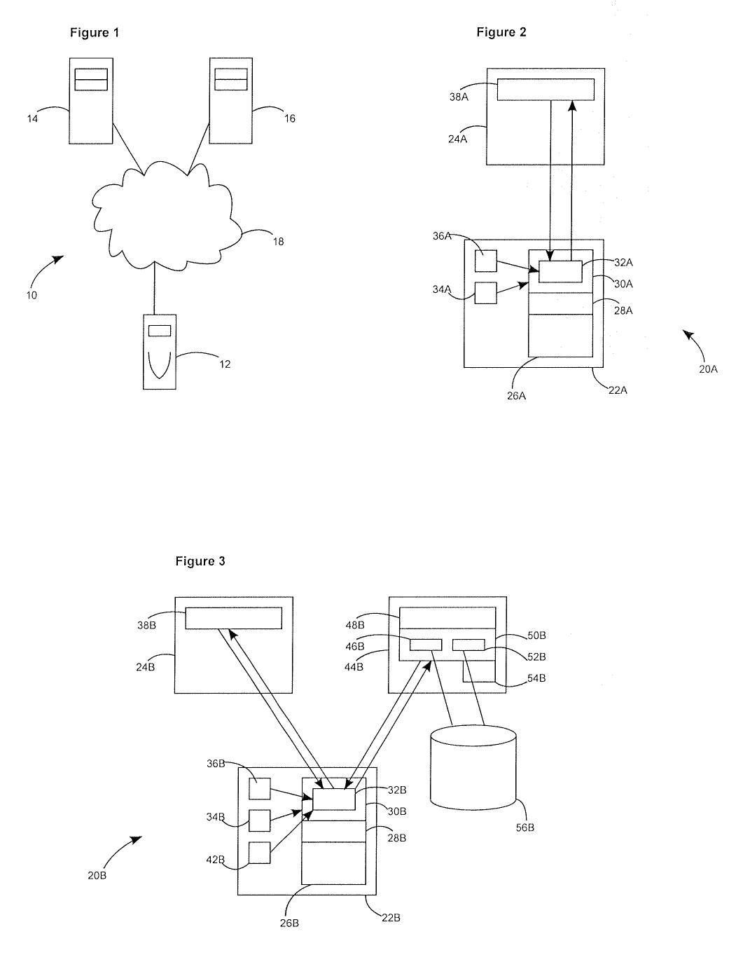

The present invention relates to systems and methods for facilitating interoperability between IBM®'s WMQWF and WPS and can be implemented in hardware, software, firmware or any combination thereof. In a preferred embodiment, the invention is implemented with a computer program that operates a computing device such as the computing devices 12, 14, 16 illustrated in FIG. 1. In one embodiment the computing system 10 includes a client computing device 12 and at least one server computing device 14, 16 connected through a communications network 18. The communications network 18 may include a local area network, a wide area network, the Internet, a direct wired connection, an infra-red connection or any other communication architecture between a plurality of computing devices as would be understood by a person having ordinary skill in the art. In another embodiment, the invention may be implemented with a special purpose computer such as an application-specific integrated circuit (ASIC), a network appliance, or a computer specifically configured to run IBM WMQWF or WPS. A computer specifically configured to run WMQWF include at least 1 GB of RAM and a 500 MHz CPU.

The computer program is stored in or on a computer-usable medium, such a computer-readable medium, residing on or accessible by a computing device, such as client computing device 12 or server computing device 14, 16, for instructing the computing devices 12, 14, 16 to implement the methods and their other functions as described herein. The computing device may include a client computing device 12 or a server computing device 14, 16 as described below. The computer program preferably comprises an ordered listing of executable instructions for implementing logical functions in the host computer and other computing devices coupled with the host computer. The computer program can be embodied in any computer-usable medium for use by or in connection with an instruction execution system, apparatus, or device, such as a computer-based system, processor-containing system, or other system that can fetch the instructions for the instruction execution system, apparatus, or device, and execute the instructions. The computer program may execute within an operating system on dedicated hardware or may execute within an operating system on virtual hardware.

The method is especially suited for implementation on a single computing device or computer network, such as the client computing device 12 depicted in FIG. 1. The computer system 10 comprises at least a client computing device 12 or a server computing device 14, 16. The client device 12 or server device 14, 16 may include a single physical device, a logical cluster, or be part of a cloud architecture. The computer will likely be part of a communications network 18 that includes one or more server computers 14, 16 running WMQWF or WPS. The computer program and equipment described herein are merely examples of a program and equipment that may be used to implement embodiments of the invention and may be replaced with other software and computer equipment without departing from the scope of the present invention. It will be appreciated, however, that the principles of the present invention are useful independent of a particular invention, and that one or more of the steps described herein may be implemented without the assistance of a computing device.

FIG. 2 illustrates a preferred embodiment of the invention implemented within a system 20A, in which a client program 26A written for WMQWF resides on a client computing device 22A. The client program 26A can be a standalone program with or without its own graphical user interface (GUI) or, for example, a distributed application residing in an EJB container which utilizes a web-based GUI. The client program will likely utilize the standard WMQWF library 28A, distributed by IBM® as fmcjapi.jar. This invention adds an extender 30A to the standard WMQWF library 28A to overload its operation. In this preferred embodiment, WMQWF 38A will be version 3.6 which enables the extender 30A to overload the operation of the standard WMQWF library 28A. In an alternate embodiment, the invention could supply it's own interface that duplicates that of the WMQWF library 28A. When client program 26A executes a function in the WMQWF client library 28A, instead of executing the WMQWF client code, the code of the extender 30A is called instead.

In this embodiment, the extender 30A must first determine the agent implementation class name. The agent implementation class name is listed in a properties file 34A with a predetermined property name that is loaded by the extender 30A. The agent implementation class name could be determined by other means, such as being hard-coded, stored in a database, or determined programmatically. The agent implementation class, once determined, is instantiated and stored by the extender 30A as an agent implementation object 32A. In the current embodiment, three different agent implementation classes are envisioned with three separate behaviors with each facilitating a step along a staged conversion from WMQWF to WPS. The behavior of each class is shown in FIGS. 2, 3 and 4.

The first agent implementation class is a WMQWF agent. This agent simply allows a connection to a single WMQWF device 24A. Multiple WMQWF devices organized into one cluster are also envisioned as a single WMQWF device 24A because they function as one logical device. This agent is used in the first step of the conversion to WPS. This agent allows connections from a client program 26A to a single existing WMQWF device 24A and, once confirmed that the client program 26A functions normally with this invention, the next agent implementation can be used. This allows problems to be rolled-back without significant changes elsewhere in the system. In this scenario, the agent implementation object 32A must be provided or determine the names of a device 24A running WMQWF 38A. This information can be provided by a configuration file 36A, database or programmatically.

FIG. 3 illustrates an embodiment of the invention in which a client computer program 26B communicates with WMQWF 38B and WPS 48B through an aggregated agent object 32B. This implementation is used in a federated computer system 20B and allows connections by a client program 26B residing on a client device 22B to WMQWF 38B and WPS 48B simultaneously. The computer program functions as described for FIG. 2, until the agent implementation object 32B communicates with the WMQWF device 24B or WPS device 44B. The aggregated agent class allows client applications to use both WMQWF 38B and WPS 48B simultaneously. Multiple WMQWF devices 24B, multiple WPS devices 44B or both organized into respective clusters are also envisioned as a single device because they function as one logical device. The aggregated agent implementation 32B allows, through an additional configuration parameter stored in a properties file 42B, selection of the method used to connect to the WPS device 44B. There are two choices. Both options have the same logical behavior, but the protocol used for communication with the WPS device 44B is different in each. One allows for an RMI/IIOP connection to the Conversion Service 50B; the other allows for a SOAP/HTTP connection to a Web Services interface 54B to the same. This agent implementation allows a gradual conversion of WMQWF processes to WPS. It also allows all long-running process that exist in WMQWF 38B to reach the end of their life before shutting down the WMQWF 38B device. This agent implementation class will also aggregate data returned from multiple sources to give the appearance of a single WMQWF device. Once all the business processes existing in WMQWF 38B have terminated, the final agent implementation class can be used.

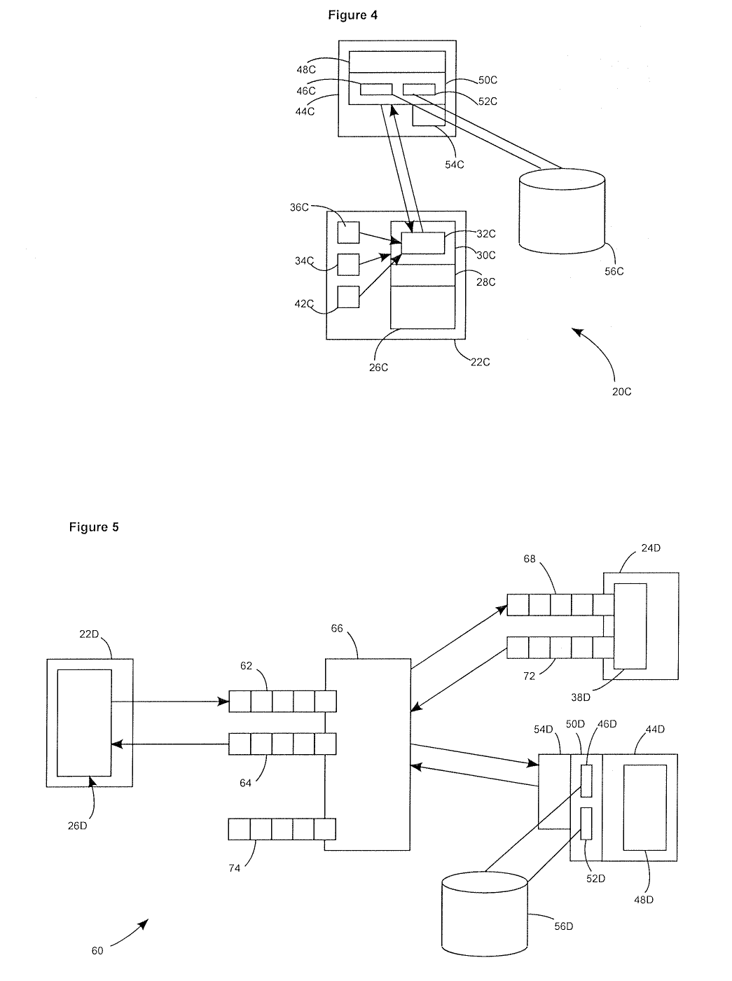

FIG. 4 illustrates an embodiment of the invention in a WPS-only computer system 20C in which a client computer program 26C communicates WPS 48C through an WPS agent object 32C. An instantiated WPS agent object 32C allows connections to a single device 44C running WPS 48C. Multiple WPS devices organized into one cluster are also envisioned as a single WPS device 44C because they function as one logical device. The WPS agent functionality is implemented in two separate classes. Both have the same logical behavior, but the protocol used for communication with the WPS device 44C is different in each. One allows for an RMI/IIOP connection to the Conversion Service 50C; the other allows for a SOAP/HTTP connection to a Web Services interface 54C to the Conversion Service 50C. All other behavior is the same. When this agent is used, any remaining WMQWF devices may be decommissioned.

Referring to FIGS. 2, 3 and 4 together, once an agent implementation object 32A, 32B, 32C is instantiated by the extender 30A, 30B, 30C, the extender 30A, 30B, 30C must determine the list of WMQWF and WPS devices 36A, 36B, 36C and a method of communicating with each device. There may be a single WMQWF device 24A as shown in FIG. 2, a single WPS device 44C, as shown in FIG. 4, or there may be WMQWF 24B and WPS 44B devices, as shown in FIG. 3, as determined by the agent implementation class used. The method of communication is likely an Internet Protocol address and associated port, but it could specify other methods such as a pipe or queue. The list 36A, 36B, 36C may reside in a text-based file on a storage medium accessible to the invention or it may reside in a database. Alternatively, the list may be determined programmatically, for example, by sending a broadcast packet on a network device that requests WMQWF 38A, 38B and WPS 48B, 48C perform an action, such as a reply to the broadcast over the network, that makes their identity known to the client 22A, 22B, 22C.

Next, the extender 30A, 30B, 30C must decide how many target devices must be called to handle to respond to the request. The number of target devices could be as low as one to as many as all the defined systems. How many systems are queried depends on agent implementation, the environment and the nature of the function called by the client library. In an environment with only one WMQWF device 24A, as in FIG. 2, or WPS device 44C, as in FIG. 4, only one target device can be called. In an environment with a plurality of WMQWF devices 24B or WPS devices 44B, as in FIG. 3, the nature of the function called is relevant to the determination.

Certain functions must be executed on every WMQWF device 24A, 24B and WPS device 44B, 44C and others are executed on only one device chosen from among all the WMQWF 24A, 24B and WPS 44B, 44C devices. An example of functions needing to be executed on all the devices are logins or a general list queries. An example of a function requiring to be executed on only a single device is a query for data pertaining to one specific object, for example a business process object.

When one or more target devices are chosen by the extender 30A, 30B, 30C, the target devices are then called. If a WMQWF direct access agent object 32A is used, as in FIG. 2, all the data in simply passed between the client program 26A and the one target WMQWF 38A without change.

However, if aggregated access, as in FIG. 3, or WPS only access is used, as in FIG. 4, more steps are involved. A stateless session EJB, the Conversion Service 50B, 50C, deployed in an EJB container on the target WPS device 44B, 44C is called with the WMQWF request.

The Conversion Service 50B, 50C must first translate the request into a format understood by WPS 48B, 48C by utilizing a first transformation code segment 46B, 46C. This transformation involves structural and syntactic changes, but may also involve semantic changes requiring data from a database 56B, 56C.

The database 56B, 56C in this embodiment is a relational database residing in the BPE database, which is created as part of WPS 48B, 48C, and augmented with additional tables and views for this invention. It is appreciated, that the database 56B, 56C need not reside with the BPE database nor does it even need to be relational in nature. One or more queries may be required to collect all the required data to facilitate the transformation.

Once the request for data is transformed into a format WPS 48B, 48C understands, the query is executed by passing the request to WPS 48B, 48C. The request may be made directly to the Conversion Service 50B, 50C or through the Web Services interface to the same 54B, 54C.

Regardless if the request made to a single WPS device 48C, as in FIG. 4, or a federated set of target devices 24B,44B, as in FIG. 3, once WPS 48B, 48C has completed the request, a code segment in the Conversion Service 50B, 50C receives the response data. The data is provided to a second transformation code segment 52B, 52C. This transformation segment 52B, 52C transforms the WPS-specific response into a WMQWF response. Again, this transformation will involve at least syntactic and structural changes. Likely, this transformation will also require semantic changes necessitating additional data to be provided. For this, the views in the BPE database 56B, 56C are queried to supplement the data. One or more queries may be required to collect all the required data to facilitate the transformation.

Once the data has been fully transformed, it is returned to the agent implementation 32B, 32C in the extender 30B, 30C. In the case of a federated system, as in FIG. 3, the agent implementation object 32B then aggregates all the data returned from all the target devices 24B, 48B queried. Based on the input parameters of the function, the data may be sorted as well.

If the extender 30C has been configured to access WPS only, as in FIG. 4, the extender behaves just as with the federated WPS system of FIG. 3, but without performing the aggregation functions required for multiple datasets. The same transformation steps must be performed, just as in the federated scenario.

FIG. 5 illustrates an embodiment of the invention implemented within a system 60 in which a client program 26D written communicates with WMQWF 38D and WPS 48D through a Message Queue interface in XML format. When a client computer program 26D residing on a client device 22D queues a message to the input queue 62, a listener service computer program 66 removes the request from the queue 62. The listener the determines the target device for the request from among all the WMQWF devices 24D and WPS devices 44D.

If the request is destined for a WMQWF computing device 24D, the message is requeued into a separate WMQWF input queue 68 for processing. A corresponding response will be queued by the same WMQWF instance 38B on a reply queue 72. The listener service 66 will monitor the reply queue 72 and queue a new reply in an output queue 64 monitored by the client computer program 26D.

If the request is destined for a WPS computing device 44D, the listener service 66 will receive a message and then call the Web Services interface 54D of the Conversion Service 50D with the request. In the Conversion Service 50D, the message data is passed to a first transformation code segment 46D and transformed syntactically, structurally and semantically into a format understood by WPS, as described previously and possibly using a database 56D. It is then executed by the WPS instance 48D, and transformed back into a WMQWF format by a second transformation code segment 52D, as previously described, and possibly utilizing data from a database 56D. The data is then returned to the listener service computer program 66. The listener service 66 then queues a response message in the output queue 64 for processing by the client computer program 26D.

An additional aspect of the MQ services listener program 66 is the caching of data from WPS 48D. Rather than repeatedly querying WPS 48D for duplicate data, returned data is cached. In addition, the cache is updated when the listener process is started, when “explicit cache” refresh messages are received on a specific queue 74, and when certain WPS errors are received. This allows some future messages, specifically process create or process “create and start” messages, to simply query the cache to determine if WPS 48D or WMQWF 38D should process the request.

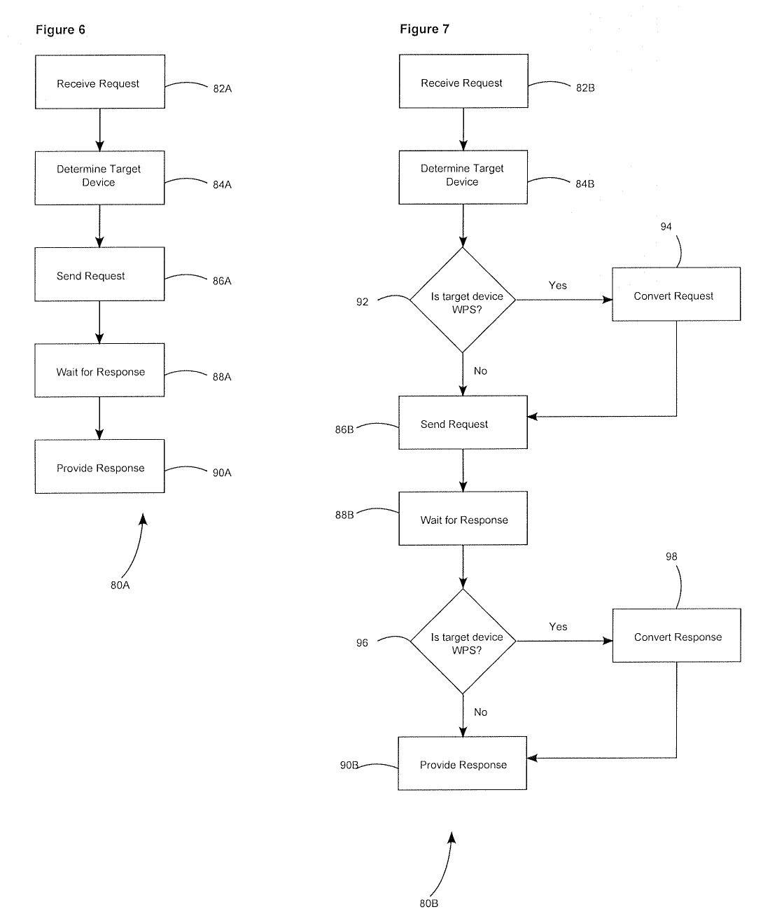

FIGS. 6-7 illustrate steps in exemplary methods 80A and 80B of using the computer system 10. Some or all of the steps may be implemented on the client computing device 22A, 22B, 22C, the server computing device 24A, 24B, 24C or by other computer programs stored in or accessed by those devices. The particular order of the steps illustrated in FIGS. 6-7 and described herein can be altered without departing from the scope of the invention. For example, some of the illustrated steps may be reversed, combined, or even removed entirely.

Method 80A shown in FIG. 6 is used by this invention when communicating with a WMQWF device. First a request is received 82A, generally from a client computer program. Then a target device must be determined 84A from among all the WMQWF devices in the system. Once the device is identified, a request must be sent to that device 86A. The computer program must then wait for a response from the target device 88A. At some time in the future, a response is created and that response must be provided to an external actor 90A. That actor is generally the same actor who created the original request.

Method 80B shown in FIG. 7 is a more a generalized method used by this invention when communicating with a WPS device. The process is the same as shown in FIG. 6 except, after the target device is determined 84B, if the target device is a WPS device 92, the request must be transformed 94 into a format understood by WPS. Then, after the response is received 88B, if the target system was a WPS device 96, the response must be transformed back into a format understood by WMQWF 98.

Although the invention has been described with reference to the preferred embodiment illustrated in the attached drawing figures, it is noted that equivalents may be employed and substitutions made herein without departing from the scope of the invention as recited in the claims.

In this disclosure, references are made to the WMQWF device 24A, 24B, 24D and the WPS device 44B, 44C, 44D. WMQWF and WPS are software applications that reside on a physical device. Therefore, the phrase WMQWF device specifically refers to the computing device having WMQWF installed thereon. Similarly, WPS device specifically refers to the computing device having WPS installed thereon.

Having thus described the preferred embodiment of the invention, what is claimed as new and desired to be protected by Letters Patent includes the following:

1. A computer readable memory device having stored thereon a computer program for allowing a client computer program written to communicate with WMQWF to communicate with computing elements running WMQWF or WPS, comprising:
a receiving code segment for receiving a request from said client computer program;
a target device selection code segment for determining a target device from said request and a list of said computing elements;
a dispatch code segment for sending said request to said target device;
a monitor code segment for waiting for a response from said target device; and
a response code segment for providing said response to said client code segment.

2. The computer readable memory device of claim 1, wherein said client computer program and the computing element running WMQWF or WPS are stored on the same computing device.

3. The computer readable memory device of claim 1, wherein said request is selected from the group consisting of a computer function call and an XML-coded message in a message queue.

4. The computer readable memory device of claim 1, wherein said dispatch code segment sends said request by or through the group consisting of the RMI/IIOP protocol and the SOAP/HTTP protocol.

5. The computer readable memory device of claim 1, wherein said response is chosen from the group consisting of data returned from a computer function call and an XML-coded message queued in a message queue.

6. The computer readable memory device of claim 1, wherein said set of said list of second computing elements is selected from the group consisting of a list stored in a computer text file, a list generated programmatically, and a list contained in a database.

7. The computer readable memory device of claim 1, further comprising WMQWF client libraries receiving requests from said client code segment and an extender code segment intercepting said requests from said WMQWF client libraries and providing said request to said target device selection code segment.

8. The computer readable memory device of claim 1, further comprising a transformation code segment for transforming said response from a format understood by said target device to a format understood by said client computer program.

9. The computer readable memory device of claim 8, further comprising an augmentation code segment for providing additional data to said transformation code segment.

10. The computer readable memory device of claim 9, wherein the augmentation code segment retrieves said additional data from a database.

11. The computer readable memory device of claim 1, further comprising a transformation code segment for transforming said request from a format understood by said client computer program to a format understood by said target device.

12. The computer readable memory device of claim 11, further comprising an augmentation code segment for providing additional data to said transformation code segment.

13. The computer readable memory device of claim 12, wherein the augmentation code segment retrieves said additional data from a database.

14. A computer readable memory device having stored thereon a computer program for allowing a client computer program written to communicate with WMQWF to communicate with computing elements running WMQWF or WPS, comprising:
a receiving code segment implemented on a computing device for receiving said requests from a WMQWF client library;
a target device selection code segment implemented on a computing device for determining a target device from said request and a list of said computing elements;
a first transformation code segment implemented on a computing device for transforming said request from a format understood by said client computer program to a format understood by said target device.
a dispatch code segment implemented on a computing device for sending said request to said target device;
a monitor code segment implemented on a computing device for waiting for a response from said target device;
a second transformation code segment implemented on a computing device for transforming said response from a format understood by said target device to a format understood said client computer program; and
a response code segment implemented on a computing device for providing said response to said client code segment.

15. The computer readable memory device of claim 14, wherein said client computer program and the computing element running WMQWF or WPS are stored on the same computing device.

16. The computer readable memory device of claim 14, wherein said request is selected from the group consisting of a computer function call and an XML-coded message in a message queue.

17. The computer readable memory device of claim 14, wherein said dispatch code segment sends said request by or through the group consisting of the RMI/IIOP protocol and the SOAP/HTTP protocol.

18. The computer readable memory device of claim 14, wherein said response is chosen from the group consisting of data returned from a computer function call and an XML-coded message queued in a message queue.

19. The computer readable memory device of claim 14, wherein said set of said list of second computing elements is selected from a group consisting of a list stored in a computer text file, a list generated programmatically, and a list contained in a database.

20. The computer readable memory device of claim 14, further comprising an augmentation code segment for providing additional data to said transformation code segment from a database.

21. The computer readable memory device of claim 14, further comprising an augmentation code segment for providing additional data to said transformation code segment from a database.

22. A method for allowing a client computer program written to communicate with WMQWF and computing elements running WMQWF or WPS, comprising:
receiving with a computer device a request from said client computer program;
determining with a computer device a target device from said request and a list of said computing elements;
sending with a computer device said request to said target device;
waiting with a computer device for a response from said target device;
querying additional data;
transforming said response with said additional data from a format understood by said target device to a format understood said client computer program providing with a computer device said response to said client code segment.

23. The method of claim 22, further comprising the step of querying additional data and transforming said request with said additional data from a format understood by said client computer program to a format understood by said target device before sending said request to said target device.
